(19) United States
(12) Patent Application Publication
(10) Pub. No.: US 2018/0012188 A1
(43) Pub. Date: Jan. 11, 2018

(54) SYSTEM, METHOD, AND DEVICE FOR MANAGING WORKFORCE RELATIONSHIPS

(71) Applicant: KRAMER CONSULTING LIMITED, Mississauga (CA)

(72) Inventor: Angela Laura KRAMER, Oakville (CA)

(21) Appl. No.: 15/547,660

(22) PCT Filed: Apr. 30, 2015
(86) PCT No.: PCT/CA2015/000285

§ 371 Date: Jul. 31, 2017

Related U.S. Application Data
(60) Provisional application No. 62/109,290, filed on Jan. 29, 2015.

(51) Int. Cl. G06Q 10/10; G06Q 10/06; G06Q 50/00

(52) U.S. Cl. CPC G06Q 10/1053; G06Q 50/01; G06Q 10/063112; G06Q 10/06398

(57) ABSTRACT

There are disclosed systems, devices, and methods for managing workforce relationships. Records reflective of a plurality of employers and records reflective of a plurality of workers, and identifiers identifying a subset of the plurality of workers preferred by at least one of the employers, are maintained in at least one electronic datastore. Parameters reflecting a given job to be performed by at least one of the workers are received from a given one of the plurality of employers. The given job is presented to a selection of the plurality of workers, wherein the presenting includes transitioning from a first mode in which said job is presented to workers selected from the subset of workers preferred by the given employer, to a second mode in which said job is presented to workers selected from the plurality of workers.

### FIELD

This disclosure relates to workforce management, and more particularly, to a system, method, and device for managing workforce relationships.

### BACKGROUND

Recent years have seen a shift in the composition of workforces in many industries from full-time employees to freelancers. Employers increasingly demand a nimble, on-demand workforce to keep costs down and to meet fluid workforce needs. Accordingly, benefit-free time-limited contract work by freelancers for multiple employers has become commonplace. Further, studies predict that by 2020, more than 50% of the workforce will be freelance, representing over 60 million people in the United States and 2.2 billion people globally.

To tap into freelance talent, employers have traditionally turned to recruiters. When a job needs to be completed, an employer contacts one or more recruiters, who then search within their network of freelancers to find available talent suited to the job. However, recruitment fees are often high, and searches by recruiters can be slow.

Some employers have also made efforts to implement their own computerized systems for managing freelancer relationships. However, as each employer maintains their own systems, there is a redundancy and waste of computing resources.

According, there is a need for improved systems, methods, and devices for managing freelancer relationships that addresses that addresses one or more of the above noted problems, and/or provides alternative solutions.

### SUMMARY

In accordance with one aspect, there is provided a system for managing workforce relationships. The system includes a user definition module configured to maintain: records reflective of a plurality of employers; and records reflective of a plurality of workers; a relationship definition module configured to maintain, for at least one of the plurality of employers, identifiers identifying a subset of the plurality of workers preferred by that employer; a job definition module configured to receive, from a given one of the plurality of employers, parameters reflecting a given job to be performed by at least one of the workers; and a job presentation module configured to present said given job to a selection of the plurality of workers. The presentation module is configured to transition from a first mode in which said job is presented to workers selected from the subset of workers preferred by the given employer, to a second mode in which said job is presented to workers selected from the plurality of workers.

In accordance with another aspect, there is provided a computer-implemented method for managing workforce relationships. The method includes: maintaining, in at least one electronic datastore, records reflective of a plurality of employer and records reflective of a plurality of workers; maintaining, in the at least one electronic datastore, identifiers identifying a subset of the plurality of workers preferred by that employer; receiving, by way of a network interface, from a given one of the plurality of employers, parameters reflecting a given job to be performed by at least one of the workers; and presenting, by way of the network interface, said given job to a selection of the plurality of workers. The presenting includes transitioning from a first mode in which said job is presented to workers selected from the subset of workers preferred by the given employer, to a second mode in which said job is presented to workers selected from the plurality of workers.

Many further features and combinations thereof concerning embodiments described herein will appear to those skilled in the art following a reading of the instant disclosure.

### DESCRIPTION OF THE FIGURES

In the figures,

FIG. 1 is a network diagram including a server adapted to function as a freelancer relationship management platform, employer devices, and freelancer devices, in accordance with an embodiment;

FIG. 2 is a high-level block diagram of application modules executing at the server of FIG. 1, in accordance with an embodiment;

FIG. 3 is a high-level block diagram of hardware components of the server of FIG. 1, in accordance with an embodiment;

FIG. 4 depicts an example screen including a freelancer profile generated at the server of FIG. 1, in accordance with an embodiment;

FIG. 5 depicts an example interface for creating a new job listing, for presenting to an employer device of FIG. 1, in accordance with an embodiment;

FIG. 6 depicts an example interface for displaying the status of a new job listing, for presenting to an employer device of FIG. 1, in accordance with an embodiment;

FIG. 7 depicts an example interface for inviting preferred freelancers to apply for a job, for presenting to an employer device of FIG. 1, in accordance with an embodiment;

FIG. 8 depicts an example interface for displaying a user-customized calendar, for presenting to a freelancer device of FIG. 1, in accordance with an embodiment;

FIG. 9 depicts an example interface for displaying information relating to a job, for presenting to a freelancer device of FIG. 1, in accordance with an embodiment;

FIG. 10 depicts an example interface for defining a freelancer's availability, for presenting to a freelancer device of FIG. 1, in accordance with an embodiment;

FIG. 11 depicts example mobile device interfaces, for presenting to a freelancer device of FIG. 1, in accordance with an embodiment;

FIG. 12 depicts an example interface for listing applicants, for presenting to an employer device of FIG. 1, in accordance with an embodiment;

FIG. 13 depicts an example interface for displaying the status of freelancers invited to apply for a job, for presenting to an employer device of FIG. 1, in accordance with an embodiment;

FIG. 14 depicts an example interface for providing a survey to a freelancer regarding a completed job, for presenting to a freelancer device of FIG. 1, in accordance with an embodiment;

FIG. 15 depicts an example interface showing a user profile for a freelancer, in accordance with an embodiment;

FIG. 16 depicts an example interface for tracking of hours worked by a freelancer, for presenting to a freelancer device of FIG. 1, in accordance with an embodiment; and

FIG. 17 and FIG. 18 are each flowcharts depicted example operations performed at the server of FIG. 1, in accordance with an embodiment.

### DETAILED DESCRIPTION

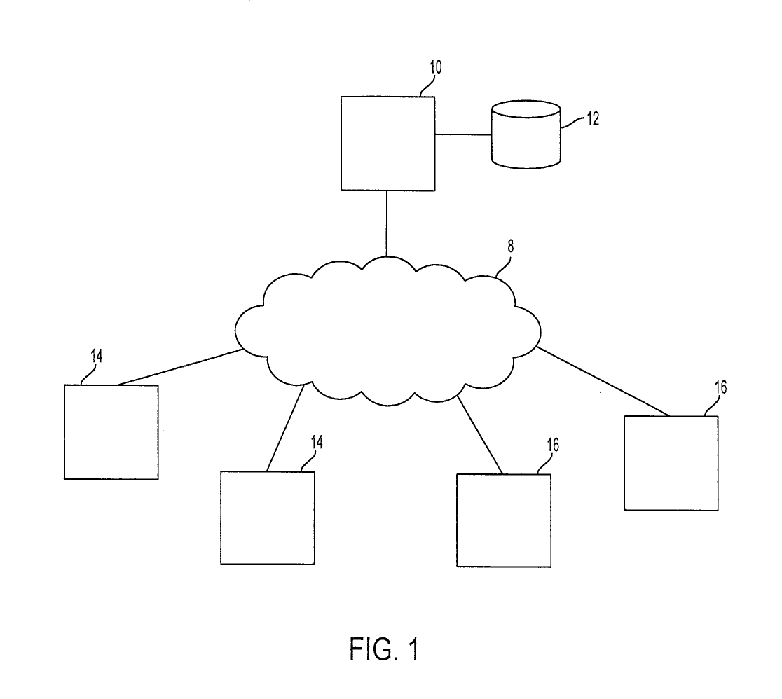

FIG. 1 illustrates a computer network 8, a network-interconnected server 10, and network-interconnected user devices 14 and 16, in accordance with an embodiment. As will be detailed herein, server 10 is a computing device that includes software adapting the device to function as a freelancer relationship management platform. In particular, this platform allows employers, operating employer devices 14, to interact with freelancers, operating freelancer devices 16. For example, this platform allows employers to define freelance jobs, which may then be presented to selected freelancers. Freelancers may be selected automatically, e.g., by matching job requirements with freelancer qualifications, freelancer availability, etc. These and various other functionalities of the freelancer relationship management platform, characteristic of embodiments, will be detailed herein.

Server 10 is configured to maintain records reflective of a plurality of employers registered to use the freelancer relationship management platform, records reflective of a plurality of freelancers registered to freelancer relationship management platform, and records of a plurality of jobs offered by the employers, to be performed by one or more of the freelancers. Such records may be stored in one or more electronic datastores 12 interconnected with server 10.

Server 10 is also configured to maintain, for at least one of the employers, identifiers identifying a subset of the freelancers preferred by that employer. Such a subset of freelancers preferred by an employer may be referred to herein as the employer's “Little Black Book”. The identifiers of preferred freelancers may be stored in an electronic datastore 12. In some embodiments, server 10 may store identifiers of preferred freelancers for multiple employers registered to use the freelancer relationship management platform. In some embodiments, server 10 may store identifiers of preferred freelancers for each employer registered to use the freelancer relationship management platform.

Each electronic datastore 12 may include a conventional relational database such as a MySQL™, Microsoft™ SQL, MariaDB™, Oracle™ database, or the like. Each of these datastores 12 may also include another type of database such as, for example, an objected-oriented database or a NoSQL database. Server 10 may include a conventional database engine (not shown) for accessing datastores 12, e.g., using queries formulated using a conventional query language such as SQL, OQL, or the like.

Server 10 is also configured to receive, from employers, parameters for new jobs to be performed by one or more of the freelancers. Such parameters may be received from one or more employer devices 14, operated by the one or more employers, by way of network 8. In an embodiment, server 10 may receive such parameters via an HTTP interface, accessible by way of devices 14. Accordingly, server 10 may include a conventional HTTP application (e.g., Apache HTTP Server, nginx, Microsoft IIS, or the like) adapting server 10 to function as an HTTP server, e.g., to send/receive HTTP messages.

Server 10 is also configured to present each job to a selection of the freelancers. As noted, freelancers may be selected automatically for each job, based on various criteria disclosed herein. In an embodiment, server 10 is configured to first present a job to freelancers selected from the subset of freelancers preferred by the employer offering the job. If the job is not filled, server 10 then presents the job to other freelancers, e.g., selected from all freelancers registered to use the freelancer relationship management platform. So, server 10 is configured to transition from a first (private) mode in which the job is presented to freelancers selected from the subset of preferred freelancers, to a second (public) mode in which the job is presented to freelancers selected from all freelancers.

Conveniently, this embodiment allows each employer to maintain a customized list of preferred freelancers (e.g., freelancers with whom they have worked with, or who have been recommended to the employer), without requiring the employer to deploy and maintain their own computerized system for managing freelancer relationships. For each employer, preferred freelancers may be provided an opportunity to review/fill a job offered by that employer, before that opportunity is provided to other freelancers.

In an embodiment, server 10 may be configured to transition from the first mode to the second mode in response to receiving user input (e.g., from an employer device 14) representative of a single mouse click, a single gesture input, a single touch input, or the like.

Server 10 may present jobs to freelancers by transmitting job data to one or more freelancer devices 14 operated by one or more freelancers, by way of network 8, in manners detailed below. In an embodiment, such job data may be transmitted via an HTTP interface.

Server 10 may be also be configured to operate in various manners described below, e.g., to allow freelancers to review and apply to jobs, to allow employers to accept applications, to track hours worked by freelancers and automatically bill employers, to allow employers and freelancers to exchange feedback, etc.

As will be detailed herein, interoperation of server 10, devices 12, and devices 14 allows freelancers to be assigned to jobs in manners that improve efficiency and reduce costs, including computing efficiency and costs. By way of one example, providing a centralized data store, e.g., for data reflective of employers, freelancers, and jobs at server 10, avoids redundancy of data storage by multiple employers and freelancers. By way of another example, allowing employers and freelancers to engage each other directly, avoids overhead costs associated recruiters.

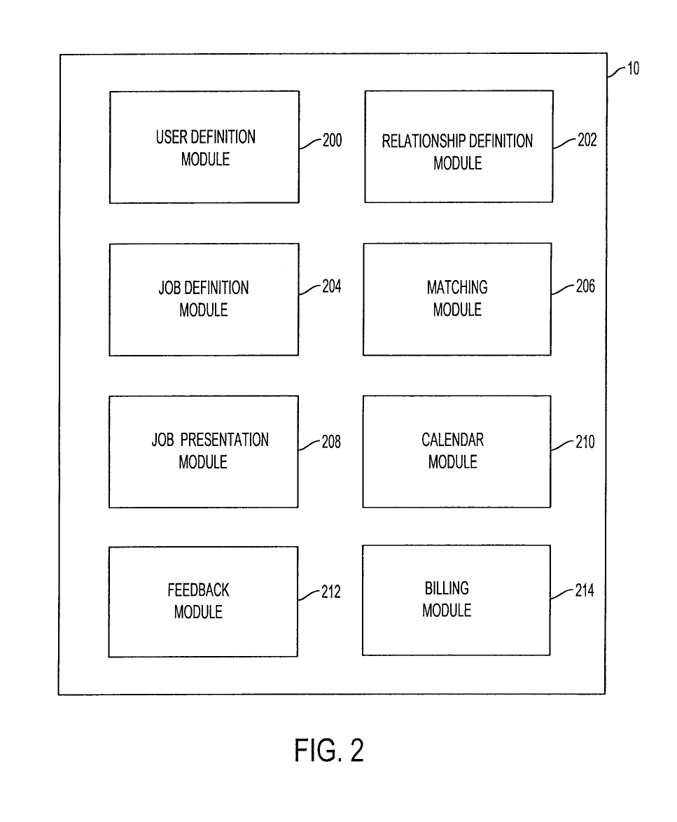

FIG. 2 illustrates various application modules that may be executed at server 10 to adapt it to function as a freelancer relationship management platform, in accordance with an embodiment. As shown, these modules include a user definition module 200, a relationship definition module 202, a job definition module 204, a matching module 206, a job presentation module 208, a calendar module 210, a feedback module 212, and a billing module 214. The functionality of each of these modules is described below.

Each of these modules may be implemented in a high-level programming language, e.g., a procedural language, an object-oriented language, a scripting language, or any combination thereof. For example, each of these modules may be implemented using C, C++, C#, Python, Peri, Java, or the like. Each of these modules may also be implemented in assembly or machine language. Each of the modules may be in the form of an executable program, a script, a statically linkable library, or a dynamically linkable library.

As will be appreciated, the modules depicted in FIG. 2 are examples only, in accordance with an embodiment. In other embodiments, the functionality described herein with reference to these modules may be organized in a fewer or a greater number of modules. Further, in some embodiments, server 10 includes only a subset of the depicted modules and/or only a subset of the functionality provided by the depicted modules.

Server 10 may be embodied in any networked computing device, such as a personal computer, workstation, server, portable computer, or the like.

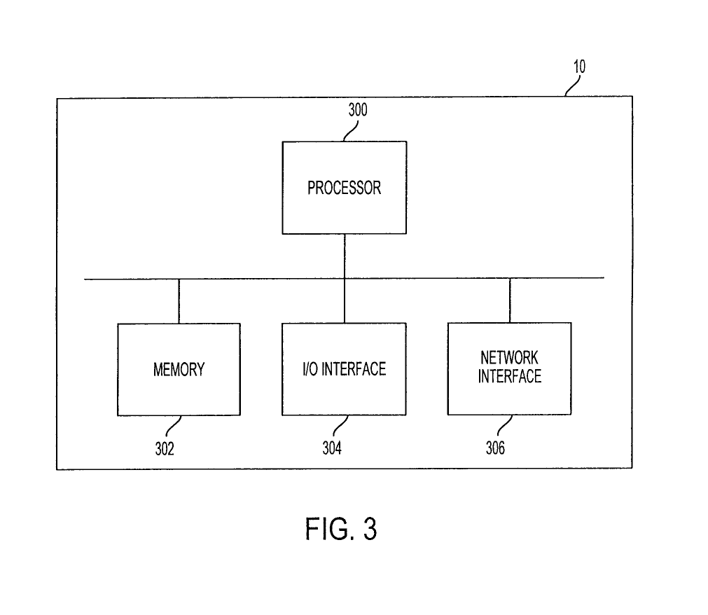

FIG. 3 is a block diagram depicting hardware components of server 10, according to an embodiment. As illustrated, server 10 includes at least one processor 300, memory 302, at least one I/O interface 304, and at least one network interface 306.

Each processor 300 may be any type of processor, such as, for example, any type of general-purpose microprocessor or microcontroller, a digital signal processing (DSP) processor, an integrated circuit, a field programmable gate array (FPGA), a reconfigurable processor, or any combination thereof.

Memory 302 may be any type of electronic memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. In an embodiment, electronic datastore 12 (FIG. 1) may reside in memory 302. In an embodiment, code for each of the application modules depicted in FIG. 2 may reside in memory 302.

Each I/O interface 304 enables server 10 to communicate with input and output devices, e.g., peripheral devices or external storage devices. Such peripheral devices may include one or more input devices, such as a keyboard, mouse, camera, touch screen and a microphone, and may also include one or more output devices such as a display screen and a speaker. In an embodiment, an I/O interface 304 may function as a data communication interface allowing user definition module 200 to receive data reflective of freelancers, employers, and/or jobs.

Each network interface 306 enables server 10 to communicate with other network-interconnected devices (e.g., employer devices 14 and freelancer devices 16), to send data to and/or receive data from such other devices, and to access and connect to network resources by way of one or more networks (e.g., network 8).

Network 8 may be any network capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

In an embodiment, server 10 may be implemented as a physical or virtual instance using various distributed-resource technologies, such as “cloud computing”. Such distributed technologies may be interconnected by way of one or more networks (e.g., network 8). Potential benefits to “cloud computing” include ease of adding/removing resources, load balancing, etc.

Devices 14 and 16 may be any type of network-interconnected computing devices, such as a personal computer, workstation, portable computer, mobile device, smart phone, tablet computer, laptop computer, or the like. Each device 14 and 16 may have hardware architecture similar to that illustrated in FIG. 3 and described with reference to server 10. As such, the architectures of devices 14 and 16 are not separately illustrated.

Each device 14 and 16 may be configured to exchange data with server 10 by way of a web browser and/or a mobile application executing at the device 14/16.

Although FIG. 1 depicts two devices 14 and two devices 16 for clarity of illustration, there may be any number of devices 14 and devices 16.

Referring again to FIG. 2, user definition module 200 is configured to allow users to register with the freelancer relationship management platform provided at server 10.

For example, user definition module 200 may be configured to present one or more interfaces accessible by way of employer devices 14, allowing employers to register with the platform. Employers may include, for example, advertising and marketing agencies, professional services companies, media agencies, computer software companies, information technology companies, start-ups, etc.

The interfaces presented by user definition module 200 to employers may be configured to allow an employer to provide various characteristics including, for example, name, logo, address, contact information, industry, past clientele, ratings, associations with other companies, employment benefits (e.g., gym memberships), etc. These interfaces may also be configured to allow a freelancer to upload and/or link to documents providing additional employer information. User definition module 200 receives such information (characteristics, documents, links, etc.) and creates an electronic record for the employer including the received information. User definition module 200 stores this electronic record in electronic datastore 12. User definition module 200 is also configured to present these or similar interfaces configured to allow an employer to change, add, or remove characteristics, e.g., after registration.

Similarly, user definition module 200 may be configured to present one or more interfaces accessible by way of freelancer devices 16, allowing freelancers to register with the platform. Freelancers may include, for example, trained agency-level talent such as art directors, copyrighters, or the like; digital and technology experts such as programmers, designers or the like, marketing professionals, project managers, etc.

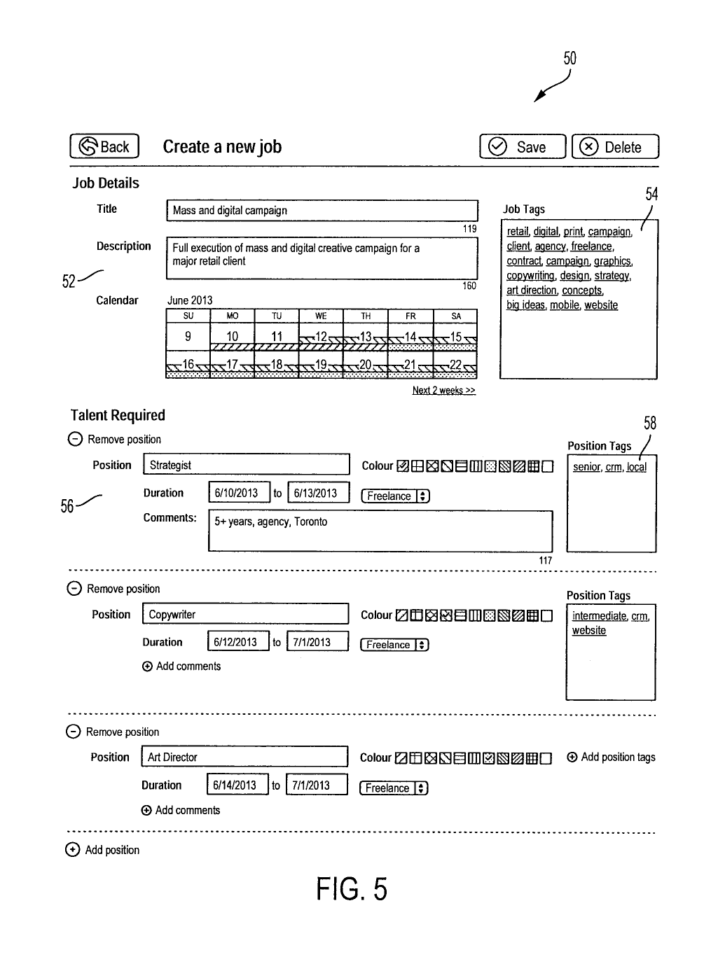

The interfaces presented by user definition module 200 to freelancers may be configured to allow a freelancer to provide various characteristics including, for example, name, portrait, address, contact information, title, qualifications (e.g., skills, experience), accolades, ratings, education history, work history, employer references, career goals, geographical work constraints, network identifications (e.g., social, institutional, or the like), expected remuneration (e.g., hourly rate), etc. These interfaces may also be configured to allow a freelancer to enter a number of keywords (e.g., tags 48 in FIG. 5) that are descriptive of the freelancer, his/her qualifications, etc. These interfaces may also be configured to allow a freelancer to upload and/or link to documents such as a résumé, a curriculum vitae, a video interview, representative work product, portfolio summaries, etc. User definition module 200 receives such information (e.g., characteristics, tags, documents, links, etc.), and creates an electronic record for the freelancer including the received information. User definition module 200 stores this electronic record in electronic datastore 12. User definition module 200 is also configured to present these or similar interfaces configured to allow a freelancer to change, add, or remove information, e.g., after registration.

In an embodiment, user definition module 200 may be configured to automatically add further information to the electronic records stored for employers and freelancers as they use the freelancer relationship management platform.

In one example, user definition module 200 may track various metrics for an employer such as, for example, number of jobs offered through the platform, number of freelancers hired through the platform, length of time that the employer has used the platform, level of activity on the platform, etc. Similarly, user definition module 200 may track various metrics for a freelancer such as, for example, the number of jobs applied for and/or performed by the freelancer, the length of time the freelancer has used the platform, level of activity on the platform.

In another example, user definition module 200 may track achievements (e.g., badges) earned by a freelancer and/or an employer. Such achievements may be manually awarded, e.g., to a freelancer by an employer, or to an employer by a freelancer. Such achievements may also be automatically awarded by user definition module 200 (e.g., based on number of hours worked). User definition module 200 may include a number of pre-defined achievements that may be awarded to freelancers/employers.

In yet another example, user definition module 200 may automatically assign tags to a freelancer based on their activity through the platform. For example, if a freelancer completes multiple jobs requiring user interface design experience, user definition module 200 may automatically assign the “UX” tag to the freelancer based on this work experience. In an embodiment, tags may be suggested to the user for approval before they are automatically assigned.

The electronic records stored for employers and freelancers may be updated to include these noted metrics and achievements.

In an embodiment, user definition module 200 may process an electronic record stored for a user to generate a graphical user profile, which may be presented to one or other of devices 14 and 16.

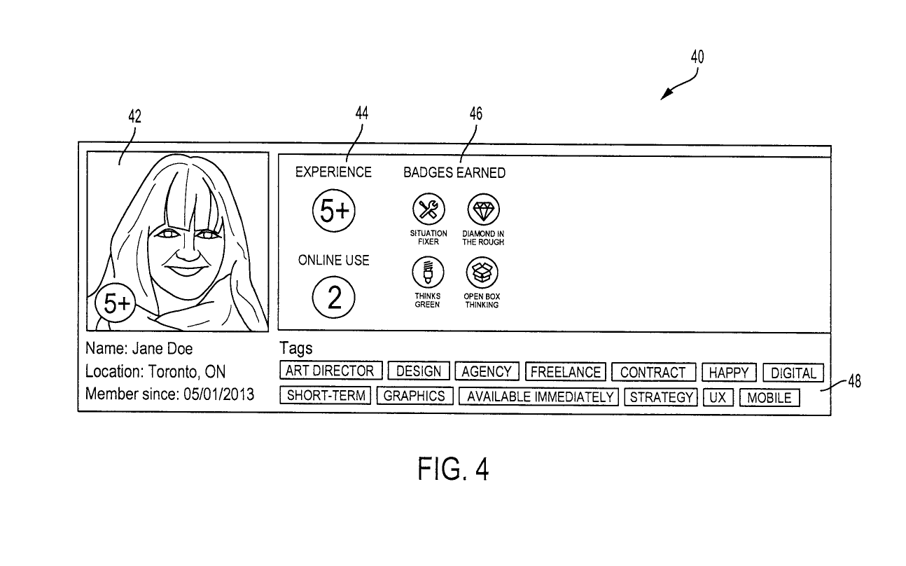

FIG. 4 depicts an example graphical user profile 40, generated for a freelancer. As depicted, profile 40 shows characteristics 42 including the freelancer's name, location, and a portrait; indicators 44 indicating numerical scores reflective of the freelancer's level of experience, and level of activity on the platform; badges 46 graphically representing achievements awarded to the freelancer; and tags 48 associated with the freelancer.

In an embodiment, each tag 48 may be associated with a count representing the number of times a freelancer has been endorsed in association with that tag 48. Such endorsements are further described below with reference to feedback module 212.

Profile 40 may be accessed by that freelancer (or other freelancers, or employers). Access to a user's profiles may be controlled according to privacy settings.

A similar profile may be generated for an employer, e.g., showing the employer's logo, and other information stored in the employer's electronic record.

As noted above, the freelancer relationship management platform allows employers to identify a subset of the freelancers as preferred freelancers. Relationship definition module 202 (FIG. 2) is configured to allow an employer to identify such preferred freelancers, and thereby create the employer's customized “Little Black Book”.

For example, relationship definition module 202 may be configured to present one or more interfaces accessible by way of devices 14, allowing an employer to identify certain freelancers as preferred freelancers.

In one example, these interfaces are configured to allow an employer to search amongst registered freelancers, e.g., based on name, qualifications. Employers may then select particular freelancers to identify them as preferred freelancers.

In another example, these interfaces are configured to allow an employer to identify a source of identifiers of preferred freelancers (e.g., a Google™ contact list or a LinkedIn™ contact list). In this example, relationship definition module 202 may communicate with the source (e.g., by way of one or more APIs) to obtain data identifying the preferred freelancers.

Relationship definition module 202 stores an identifier of each preferred freelancer for a particular employer, e.g., in association with the electronic record for that employer in electronic datastore 12.

In an embodiment, identification as a preferred freelancer by an employer is subject to the freelancer's approval. According, upon being selected as a preferred freelancer by an employer, an electronic notification may be sent to the freelancer requesting approval.

In an embodiment, employers may be allowed to identify freelancers who are not yet registered with the platform as preferred freelancers. In this embodiment, relationship definition module 202 may obtain contact information for the identified freelancer and send an electronic invitation to the freelancer to register with the platform.

Job definition module 204 (FIG. 2) is configured to allow employers to define new jobs to be performed by freelancers.

For example, job definition module 204 may be configured to present one or more interfaces accessible by way of devices 14, allowing employers to create records of job listings to be presented by way the platform to freelancers.

FIG. 5 depicts an example interface 50, in accordance with an embodiment. As shown, this interface allows an employer to enter various parameters for a new job listing including, for example, a summary 52 including the title and description, a set of keywords 54 (e.g., tags) descriptive of the job, qualifications required, etc. Additionally, the employer may define one or more roles 56, each to be filled by a freelancer. In the example job shown, three roles have been defined, namely, a strategist, a copywriter, and an art director. The interface also allows an employer to enter, in association with each role, a time period (e.g., a start date and an end date) during which the freelancer is expected to work for the employer. The interface also allows an employer to enter textual comments associated with the role (e.g., to elaborate on requirements). The interface also allows an employer to enter, a set of keywords 58 (e.g., tags) descriptive of the role. So, each job may include a set of keywords 56 descriptive of the job in general, and sets of keywords 58 descriptive of each role defined for the job. Additionally, the employer may set remuneration offered for the job, which may vary from role to role.

Job definition module 204 receives this job information, and creates an electronic record for the job using the received information. Job definition module 204 stores this electronic record in electronic datastore 12.

In an embodiment, job definition module 204 may also be configured to present one or more interfaces accessible by way of devices 14, allowing employers to monitor the status of job listings that have been created. For example, such interfaces may allow employers to determine whether any applicants have submitted applications for a job. Such interfaces may also allow employers to modify the parameters of a job.

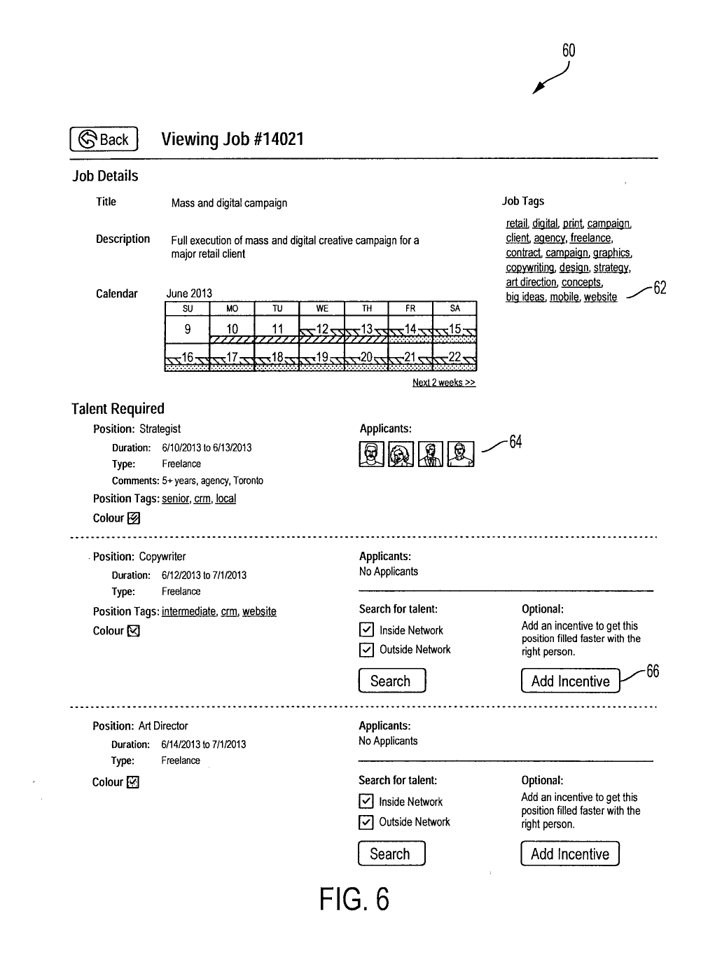

For example, FIG. 6 depicts an example interface 60 configured to allow an employer to monitor the status of a job listing, in accordance with an embodiment. This interface shows a summary 62 of the job listing, reflecting previously entered job information, as well as a calendar graphically indicating the time periods associated with each role defined for the job. Interface 60 also shows the status of applicants for job. In particular, it shows that four applicants 64 have applied for the strategist role, and that no applicants have applied for the copywriter and art director roles. Each applicant 64 is represented by a thumbnail, which may be activated (clicked) to visit the applicant's user profile (e.g., FIG. 4). For roles without applicants, this interface allows an employer to conduct searches for applicants, and also to add incentives (e.g., financial incentives such as bonuses, travel reimbursements, discounts for goods/services, a gym membership, other employment benefits, etc.).

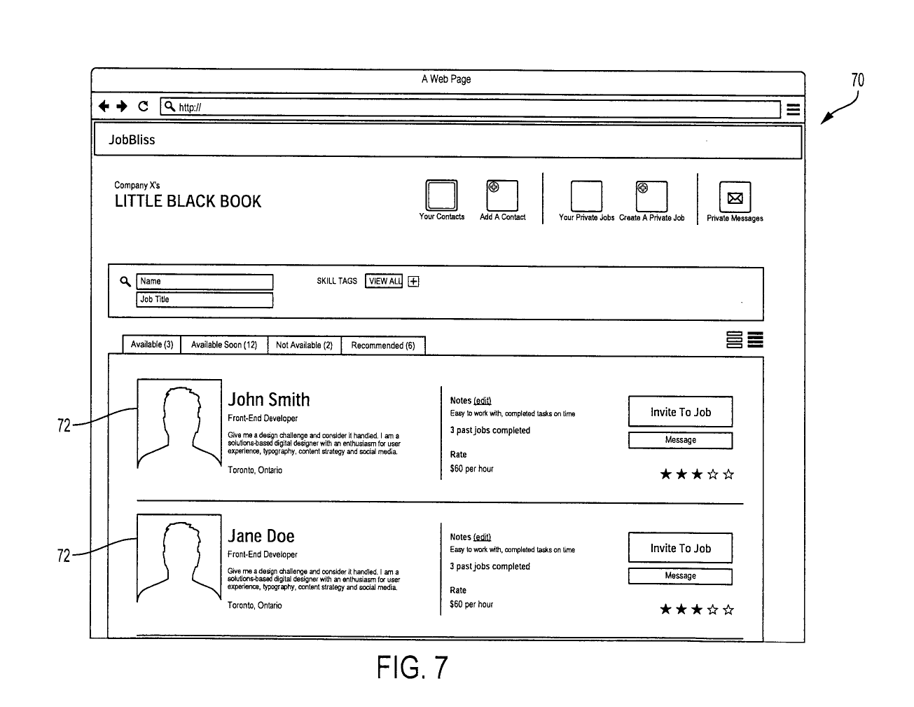

As noted, jobs may be presented first to selected preferred freelancers, and then presented to other freelancers if not filled by preferred freelancers. FIG. 7 depicts an example interface 70 presented by job definition module 204, which is configured to allow an employer to select particular preferred freelancers 72 to invite to apply for a particular job. The freelancers 72 preferred by a particular employer may be identified based on the stored identifiers noted above.

In an embodiment, interface 70 is configured to present preferred freelancers 72 matched to the job, in accordance with an embodiment. As depicted in FIG. 7, two preferred freelancers 72 have been matched to the job, and are presented to the employer as possible invitees.

Freelancers may be matched to jobs in manners described below with reference to matching module 206 (e.g., based on availability, overlap between job requirements and freelancer qualifications, etc.). In an embodiment, freelancers 72 may be sorted according to one or more quality-of-match scores, as determined by matching module 206, and presented to employers in sorted order.

If any roles of a job are not filled by preferred freelancers 72, e.g., after a certain amount of time has passed, or after preferred freelancers 72 have declined invitations to apply to the job, the job may then be presented to other freelancers, including non-preferred freelancers. Presentation to such other freelancers may be automatically triggered upon occurrence of one of the noted events. Alternatively, a job can also be opened up to such other freelancers upon receiving a request from an employer (e.g., in the form of a single mouse click and/or touch input).

Matching module 206 (FIG. 2) is configured to match freelancers to jobs. Matching module 206 processes the electronic record created for a particular job to extract its characteristics including, for example, where the work needs to be performed, number of hours required, time period, remuneration offered, qualifications required (e.g., in the form of job tags 54 and role tags 58 depicted in FIG. 5), etc. Matching module 206 also processes the electronic records created for one or more freelancers to extract their characteristics including, for example, availability, remuneration expected, geographical constraints on place of work, and qualifications (e.g., in the form of tags 48 depicted in FIG. 4).

Matching module 206 matches freelancers to jobs (i.e., particular roles) using the extracted job characteristics in conjunction with the extracted freelancer characteristics. For example, freelancers may be filtered based on remuneration expected versus remuneration offered, geographical constraints, and availability. Freelancers may be matched on the basis overlap between employer-defined tags 54/56 and freelancer-defined tags 48, with such overlap in tags reflecting an overlap in job requirements and freelancer qualifications.

In an embodiment, matching module 206 may calculate a numerical score reflective of the quality-of-match between a particular freelancer's qualifications and a particular job. For example, the score may be calculated as the number of overlapping tags. Freelancers may be ranked according to this score, and, for example, presented to employers in the ranked order. Other ways of calculating this numerical score are also possible and would be apparent to one of ordinary skill in the art.

In an embodiment, matching module 206 may calculate a numerical score reflecting a quality-of-match between a particular freelancer's career goals and a particular job. This numerical score may be calculated taking in account a variety of inputs including, for example, tags associated with the freelancer, tags associated with the job, the number of jobs completed by the freelancer, hours worked, ratings for the freelancer/employer (e.g., based on feedback data obtained after jobs are completed, as described below).

Presentation module 208 (FIG. 2) is configured to present a job to a selection of freelancers. The selection of freelancers may include freelancers who have been automatically matched to the job by matching module 206. The selection of freelancers may also include freelancers who have been manually selected for a job, e.g., by an employer who sends an invitation to a freelancer to apply for the job.

Presentation module 208 may be configured to present one or more interfaces accessible by way of devices 16, allowing freelancers to receive information regarding jobs for which they have been selected to apply. For example, presentation module 208 may present an interface displaying a list of such jobs.

Presentation module 208 may be configured to transmit notifications to freelancers alerting them of new jobs for which they have been selected to apply. Such electronic notifications may be transmitted by way of e-mail, SMS, a social media network, or the like. Such electronic notifications may be transmitted in real-time or near real-time, e.g., as soon as a freelancer is matched to a job.

In an embodiment, presentation module 208 may cooperate with calendar module 210, allowing jobs for which a freelancer has been selected to apply to be displayed in an electronic calendar customized for that freelancer.

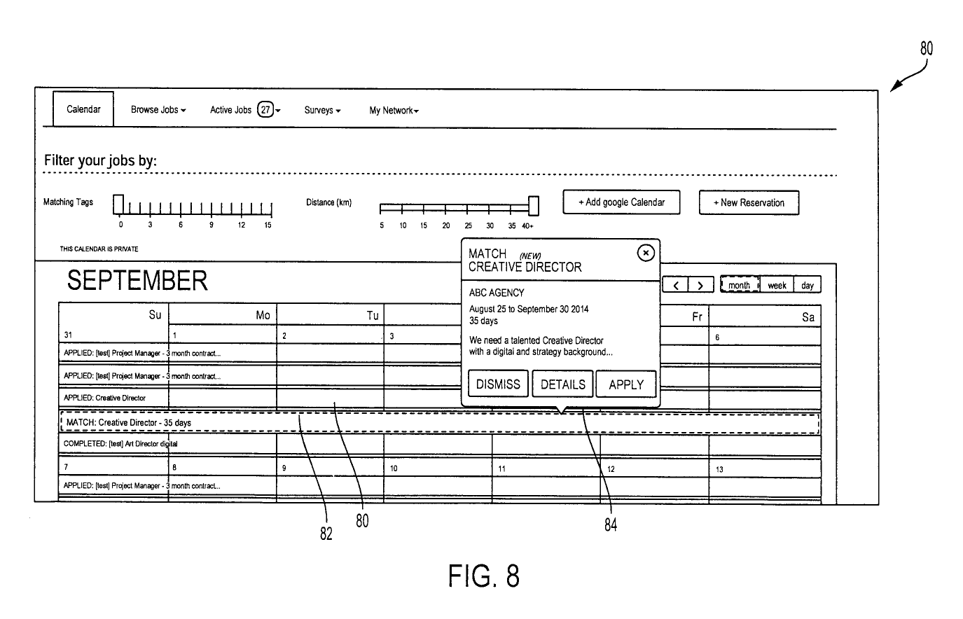

For example, FIG. 8 depicts an example interface 80 showing such a calendar, as generated by calendar module 210, in accordance with an embodiment.

As depicted, this calendar displays a job 82 that has been matched to a freelancer, to which the freelancer may apply. In an embodiment, this calendar may also include jobs 80 to which the freelancer has applied, jobs for which the freelancer has been accepted, and jobs that have been completed by the freelancer. Conveniently, in interface 80, each job is shown to span a portion of the calendar corresponding to the job's start and end dates.

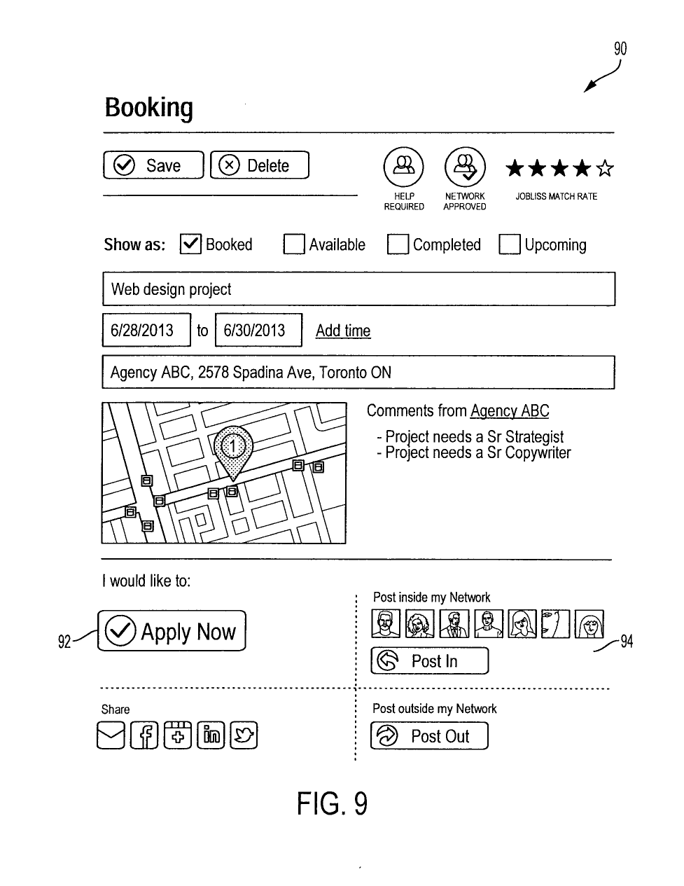

Interface 80 is configured to allow a freelancer to select (e.g., click on) a matched job to access an additional interface with information relating to the job. For example, FIG. 9 depicts such an additional interface 90, in accordance with an embodiment. Interface 90 may include information regarding the job, including for example, its title, time period, and address. Interface 90 may include a button 92 allowing the freelancer to apply for the job. Interface 90 may also include various controls allowing the freelancer to share the job with other freelancers, by way of the freelancer relationship management platform provided at server 10, or by way of a social media network.

In an embodiment, interface 80 is configured to allow a freelancer to filter for matched jobs according to various criteria, e.g., geographical constraints (e.g., distance between freelancer and job), and according to the quality-of-match scores generated by matching module 206. In this way, a freelancer may control which jobs appear in his or her customized calendar.

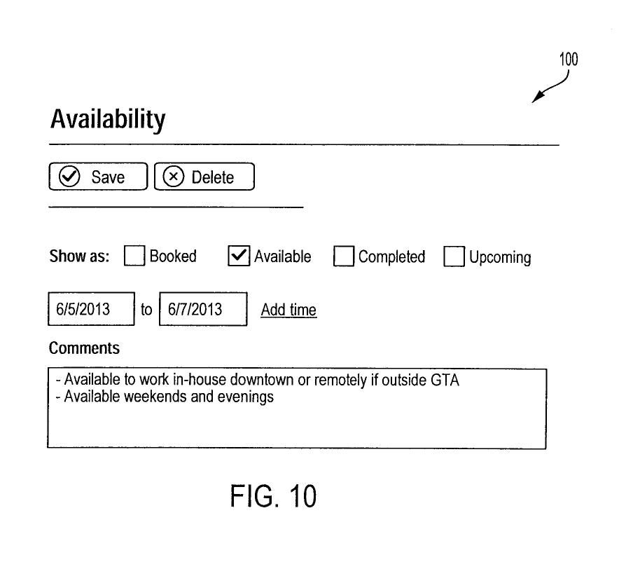

In an embodiment, interface 80 is also configured to allow a freelancer to define his or her availability for taking on jobs. For example, a freelancer may select a particular day or days on the calendar to set availability for those day(s). FIG. 10 depicts an example interface 100 configured to allow a freelancer to set availability, in accordance with an embodiment. As depicted, the interface allows a freelancer to set availability to one of several pre-defined options including, e.g., booked, available, job completed, job upcoming, etc. The interface may also allow a freelancer to indicate that certain days as being non-available, e.g., representing days off, vacations, etc.

Conveniently, cooperation of presentation module 208 and calendar module 210 provides a unified interface (e.g., in the form of a calendar) to be presented to a freelancer, facilitating the efficient completion of disparate tasks, e.g., finding available jobs, defining availability, and so on.

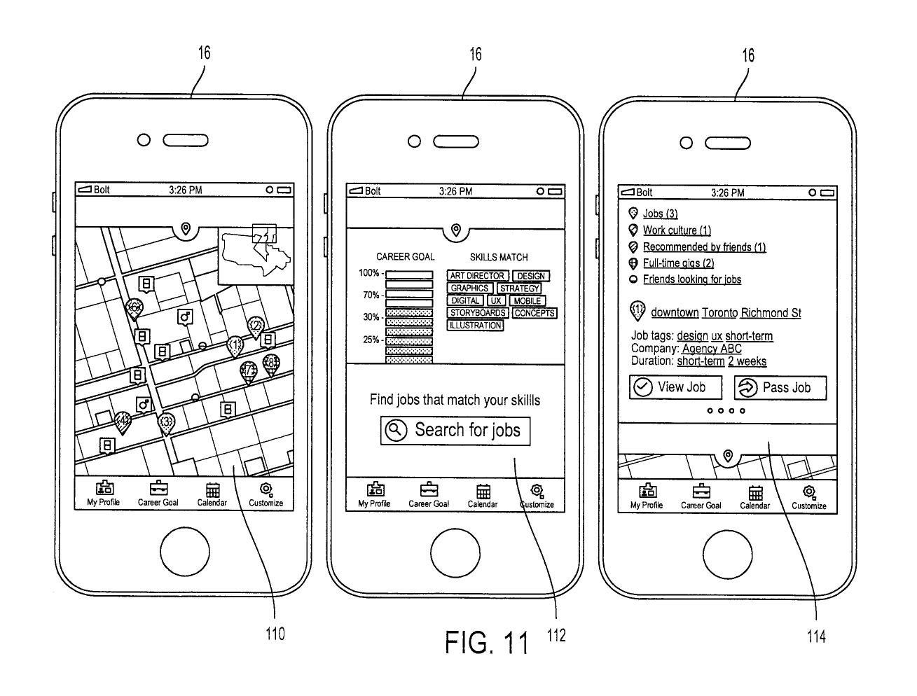

FIG. 11 depicts example mobile device interfaces 110, 112, 114 that may be displayed at freelancer device 16 based on information provided by presentation module 208, exemplary of an embodiment. These mobile devices interfaces are configured to be displayed when device 16 is a mobile device such as a smart phone, a tablet computer, or the like.

In one example, interface 110 depicts available jobs on a map, allowing freelancers to find available jobs by geographical region. In another example, interface 112 depicts a matched job, showing the tags that overlap between the freelancer and the job. Interface 112 also displays a numerical score reflective of the quality-of-match between the job and freelancer's career goals. In yet another example, interface 114 provides information regarding a matched job. As depicted, the freelancer may be presented with a “View Job” button allowing the freelancer to obtain more information regarding the job, and a “Pass Job” button allowing the freelancer to refer the job to another freelancer.

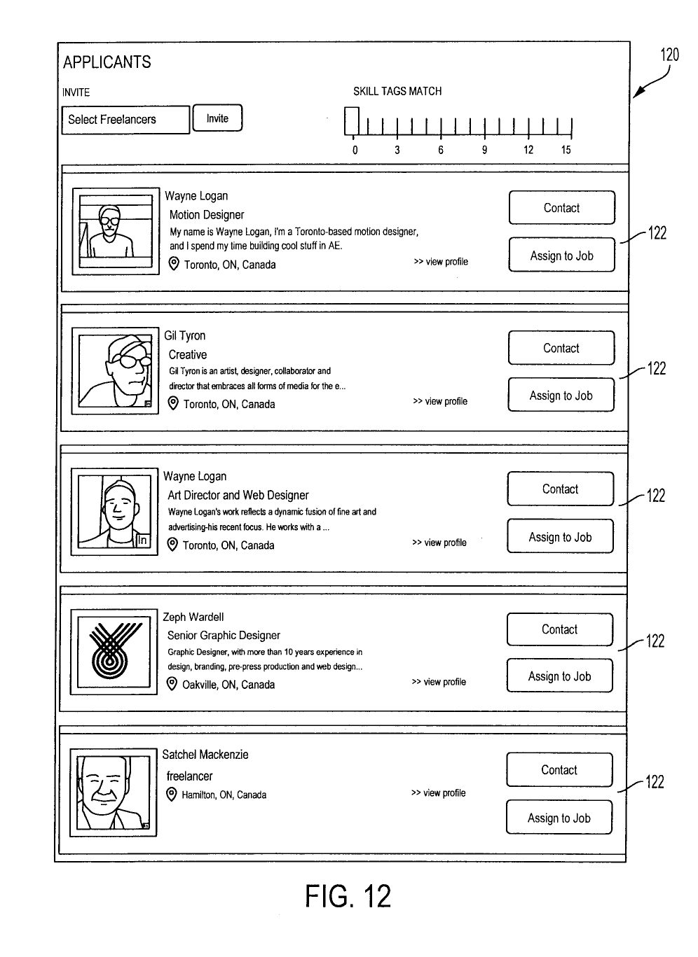

Upon being selected for a job (e.g., automatically matched or manually invited to apply), a freelancer may apply for the job by way of one of the interfaces described above (e.g., interface 90). In turn, employers may be presented with one or more interfaces showing applicants for a particular job. For example, FIG. 12 depicts an example interface 120 configured to display to an employer a plurality of freelancers 122 who have applied for a particular job, in accordance with an embodiment.

In an embodiment, interface 120 may be configured to allow an employer to filter freelancers 122 according to the quality-of-match scores for applicant qualifications noted above. For example, interface 120 may omit freelancers having a score below a user-selected threshold. Freelancers 122 may be sorted according to this score. Interface 120 may also be configured to display, in association with each matched freelancer 122, an option for contacting the freelancer or to assign (accept) the freelancer for the job.

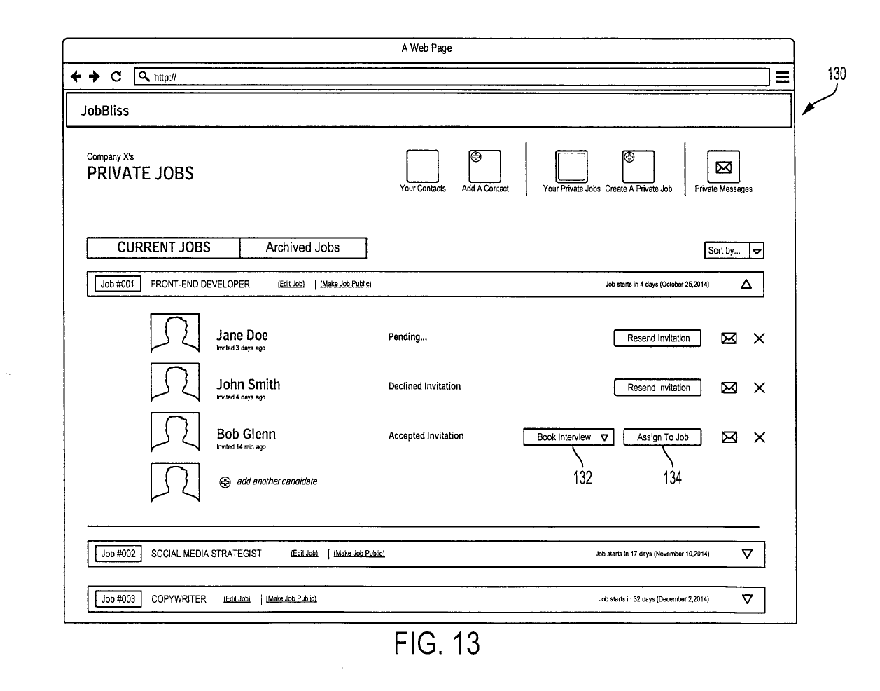

FIG. 13 depicts an example interface 130 configured to display to an employer the status of freelancers who have been invited to apply for a job (e.g., from an employer's list of preferred freelancers), in accordance with an embodiment. As depicted, interface 130 may show that certain invited freelancers have not responded to an invitation to apply (e.g., Jane Doe), that certain invited freelancers have declined an invitation to apply (e.g., John Smith), and/or that certain invited freelancers have accepted an invitation to apply (e.g., Bob Glenn). When a freelancer has accepted an invitation, interface 130 may display a button 132 to book the freelancer for an interview, and a button 134 to accept the freelancer for the job.

In an embodiment, when a freelancer has been accepted for a job, an electronic notification notifying the freelancer of the acceptance may be automatically transmitted by the platform to the freelancer, e.g., by way of e-mail, SMS, a social media network, or the like.

In an embodiment, the platform may automatically adjust the availability of a freelancer based the acceptance, e.g., to set the freelancer's availability to “booked” during the job's duration.

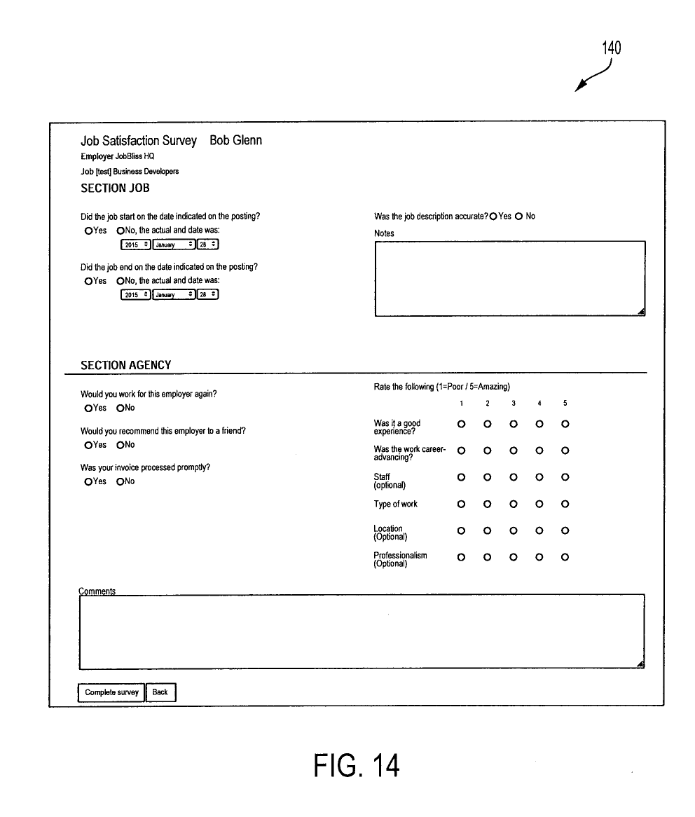

Feedback module 212 (FIG. 2) is configured to allow freelancers and employers to exchange feedback, e.g., upon completion of a job. For example, feedback module 212 may be configured to present one or more interfaces accessible by devices 14 and 16 for obtaining feedback from freelancers regarding employers, and obtaining feedback from employers regarding freelancers. FIG. 14 depicts an example interface 140 providing a survey for completion by a freelancer regarding an employer in respect of a completed job, in accordance with an embodiment. As depicted, interface 140 may include a series of questions regarding the employer/job, allowing the freelancer to answer positively or negativity, or along a scale. Feedback module 212 may include a similar interface providing a survey for completion by an employer regarding a freelancer in respect of a completed job.

In an embodiment, feedback module 212 may be configured to obtain feedback from employers and/or freelancers before completion of a job (e.g., periodically during the duration of a job, upon achievement of particular milestones, upon request by an employer or a freelancer, etc.).

In an embodiment, feedback module 212 may be configured to process feedback obtained from an employer to update the electronic record for a freelancer to incorporate the employer's feedback. In one example, feedback module 212 processes the feedback to determine whether the feedback is positive or negative in aggregate. When the feedback is positive, feedback module 212 automatically endorses the freelancer for the qualifications (e.g., skills) relevant to the completed job. For example, feedback module 212 may determine the relevant qualifications as those qualifications overlapping between the freelancer-defined tags 48 and the employer-defined tags 54/58. Feedback module 212 then automatically increases a count (e.g., +1) associated with each of the overlapping tags.

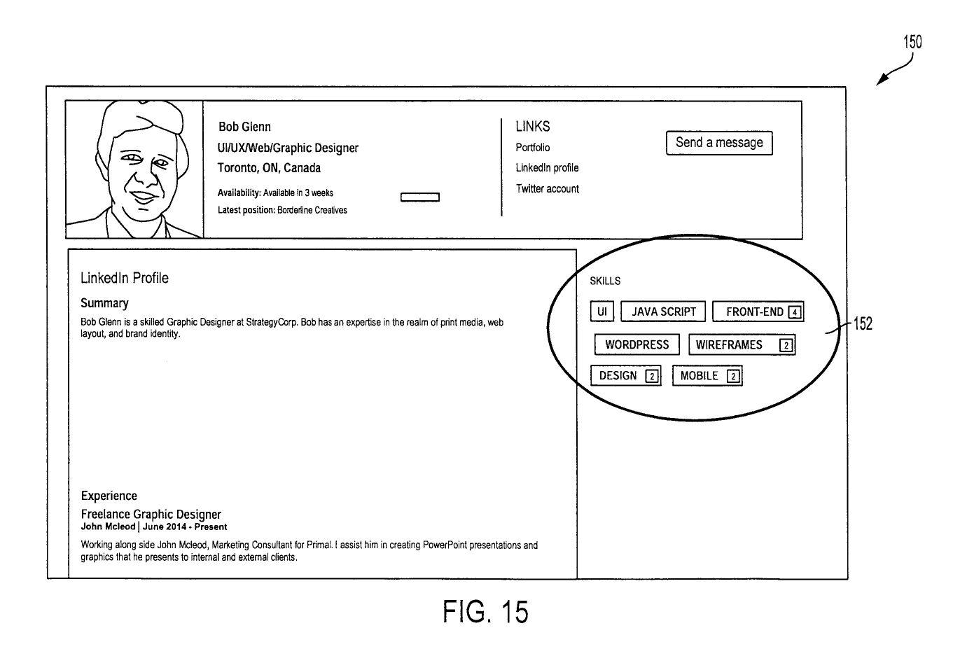

FIG. 15 shows an example user profile for a freelancer, in accordance with an embodiment. As depicted, this user profile includes tags 152 displayed in association with the number of times the freelancer has been endorsed for a particular skill. For example, the tags include a “Design” tag shown in association with a count “2”. This indicates that the freelancer has completed two jobs to the satisfaction of employers when the electronic record for the job was created with the “Design” tag.

In this way, the platform links endorsement of qualifications with successful completion of jobs. As such, in this embodiment, positive endorsement of qualifications is evidence-based.

In an embodiment, feedback module 212 may adjust the counts associated with a freelancer's tags only when both the freelancer and the employer provide positive feedback for each other.

Billing module 214 (FIG. 2) is configured to track quantum of work completed by a freelancer, e.g., in terms of hours worked or number of deliverables submitted, and then automatically generate invoicing data.

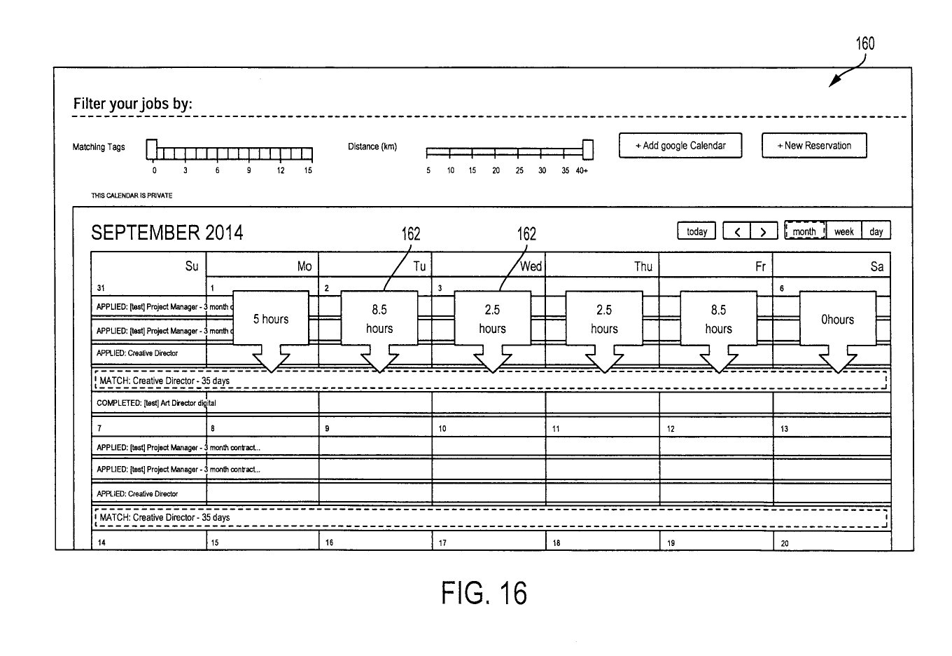

Billing module 214 may track quantum of work for a job by way of updates received from devices 16. For example, FIG. 16 is an example screen that may be presented at a freelancer device 16, and illustrates updates 162 corresponding to hours worked per day, as may be entered by a freelancer. Such updates may be transmitted to server 10 periodically (e.g., at the end of each day), or upon completion of a job.

Billing module 214 may transmit the tracked quanta to an employer device 14, to obtain approval from an employer for invoicing purposes. In turn, billing module 214 may receive approval for some or all of the tracked quanta from a device 14. Approval may be sought periodically (e.g., at the end of each day), or upon completion of a job.

Billing module 214 may determine remuneration rates applicable to a job based on the job listing, or based on rates associated with a particular freelancer (e.g., set as part of the freelancer's user profile).

Billing module 214 may be configured to export data reflective of quantum of work and remuneration rates (e.g., hourly rates) for processing by an employer. In an embodiment, billing module 214 may export such data in a format suitable for processing in financing software such as Quickbooks™ or Freshbooks™ for invoicing and accounting purposes. In an embodiment, billing module 215 may transmit such data to a third-party invoicing service.

Billing module 214 may be configured to automatically generate invoices, e.g., based on the tracked quantum of work and remuneration rates. Such invoices may be transmitted to employer devices 14.

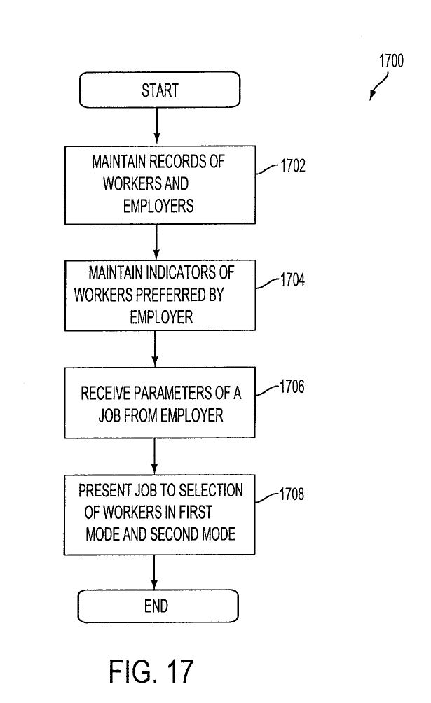

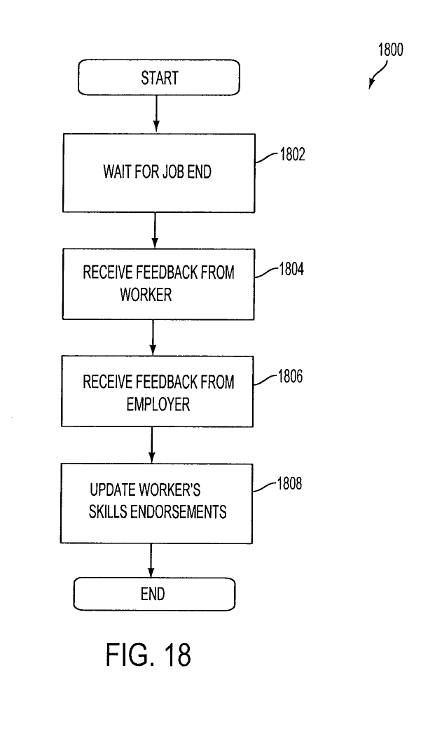

The operation of the freelancer relationship management platform provided at server 10 may be further described with reference to the flowcharts of FIG. 17 and FIG. 18, which each show blocks that may be performed at server 10 in accordance with an embodiment.

The blocks shown in FIG. 17 and FIG. 18 are provided as examples only, in accordance with an embodiment. Other, different, additional, fewer blocks may be performed in other embodiments. Further, some blocks may be combined.

Blocks 1700 and onward depicted in FIG. 17 may be performed at server 10 for presenting jobs to freelancers.

Operation begins with registration of employers and freelancers. For example, at block 1702, user definition module 200 creates electronic records for employers based on information received from employer devices 14. User definition module 200 also creates electronic records for freelancers based on information received from freelancer devices 16. User definition module 200 may maintain such electronic records in an electronic datastore 12.

At block 1704, the platform creates a “Little Black Book” for one or more employers. In particular, for each of these employers, relationship definition module 202 identifies a subset of the registered freelancers as being preferred by that employer. Relationship definition module 202 maintains indicators indicating each subset of preferred freelancers, e.g., in an electronic datastore 12.

At block 1706, job definition module 204 receives, from one of the employers, parameters reflecting a particular job to be completed by one or more of the freelancers. Such parameters may, for example, be received by way of interface 50 (FIG. 5). Job definition module 204 creates an electronic record for the job based on the received parameters.

At block 1708, presentation module 204 presents the new job to a selection of freelancers. Presentation module 204 initially operates in a first mode (e.g., a private mode), in which the job is presented to freelancers selected from the subset freelancers preferred by the employer that created the job. Freelancers may be automatically selected by matching module 206, or manually by the employer (e.g., by inviting a freelancer to apply for the job). If the job (or any part thereof) is not filled by preferred freelancers, then presentation module 204 transitions to a second mode (e.g., a public mode), in which the job is presented to freelancers selected from all registered freelancers.

Conveniently, in an embodiment, presentation module 204 is configured to allow an employer to trigger a transition from the first mode to the second mode by way of a single click, a single gesture input, a single touch input, or the like.

Blocks 1706 and 1708 may be repeated for each job created by one of the employers. For each of such jobs, blocks 1706 and 1708 may be performed in parallel.

Blocks 1800 and onward depicted in FIG. 18 may be performed at server 10 once a job has been completed.

Operation begins at block 1802, at which point the platform waits for a job to end. Upon determining that the job has ended, operation proceeds to block 1804. The platform may determine that the job has ended when the end date defined for the job has been reached. The platform may also determine that the job has ended upon receiving notification from the freelancer or the employer. For example, the freelancer may mark a job as being complete by way of interface 80 (FIG. 8).

At block 1804, feedback module 212 receives data reflecting feedback from a freelancer regarding the job and/or employer.

At block 1806, feedback module 212 receives data reflecting feedback from the employer regarding the freelancer and/or the work performed.

At block 1808, feedback module 212 processes the received feedback data to determine whether the data reflects positive or negative feedback. When the feedback from the employer is positive, feedback module 212 automatically endorses the freelancer for the qualifications relevant to the completed job.

Although not illustrated, at any point following block 1802, billing module 214 may automatically generate invoicing data for the completed job.

Blocks 1800 and onward may be repeated for each job. For each of such jobs, blocks 1800 and onward may be performed in parallel.

Although embodiments have been described in the foregoing with reference to freelancers, in other embodiments, the systems, methods, and devices disclosed herein may be applied to workers more generally, including e.g., term-limited workers, contractors, and other types of skill-based talent, across various industries.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in various forms including, for example, the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

1. A system for managing workforce relationships, the system comprising:
a user definition module configured to maintain:
records reflective of a plurality of employers; and
records reflective of a plurality of workers;
a relationship definition module configured to maintain, for at least one of the plurality of employers, identifiers identifying a subset of the plurality of workers preferred by that employer;
a job definition module configured to receive, from a given one of the plurality of employers, parameters reflecting a given job to be performed by at least one of the workers; and
a job presentation module configured to present said given job to a selection of the plurality of workers, the presentation module configured to transition from a first mode in which said job is presented to workers selected from the subset of workers preferred by the given employer, to a second mode in which said job is presented to workers selected from the plurality of workers.

2. The system of claim 1, further comprising:
a feedback module configured to receive feedback data from the given employer for a given worker who performed the given job.

3. The system of claim 2, wherein the feedback module is configured to process the feedback data to determine whether the feedback data reflects positive or negative feedback.

4. The system of claim 3, wherein the feedback module is configured to, upon determining that the feedback data reflects positive feedback, update the record for the given worker to reflect endorsement for qualifications relevant to the given job.

5. The system of claim 2, wherein the feedback module is configured to receive feedback data from the given worker for the given employer.

6. The system of claim 1, further comprising:
a billing module configured to track a quantum of work completed by a given worker for the given job, and to generate an invoice for the given job based on the tracked quantum of work.

7. The system of claim 1, further comprising:
a matching module configured to select the selection of the plurality of workers, the selecting comprising:
processing the records for the plurality of workers to determine worker qualifications;
processing the parameters reflecting the given job to determine job requirements; and
matching the worker qualifications to job requirements.

8. The system of claim 1, wherein the job presentation module is configured to transmit an electronic notification to at least one of the selected workers.

9. The system of claim 1, wherein the job presentation module is configured to present said given job by way of an electronic calendar generated for a given one of the selected workers.

10. The system of claim 1, wherein the job presentation is configured to transition from the first mode to the second mode in response to receiving user input from the given employer.

11. The system of claim 10, wherein the user input is a single mouse click, a single gesture, or a single touch input.

12. A computer-implemented method for managing workforce relationships, the method comprising:
maintaining, in at least one electronic datastore, records reflective of a plurality of employers and records reflective of a plurality of workers;
maintaining, in the at least one electronic datastore, identifiers identifying a subset of the plurality of workers preferred by that employer;
receiving, by way of a network interface, from a given one of the plurality of employers, parameters reflecting a given job to be performed by at least one of the workers; and
presenting, by way of the network interface, said given job to a selection of the plurality of workers;
said presenting comprising transitioning from a first mode in which said job is presented to workers selected from the subset of workers preferred by the given employer, to a second mode in which said job is presented to workers selected from the plurality of workers.

13. The method of claim 12, further comprising:
transmitting, by way of the network interface, an invitation to at least one of the selected workers to apply for the given job.

14. The method of claim 12, further comprising:
receiving, by way of the network interface, an application from at least one of the selected workers to apply for the given job.

15. The method of claim 12, further comprising:
receiving, by way of the network interface, an acceptance from the given employer for at least one of selected workers for the given job.

16. The method of claim 12, further comprising:
receiving, by way of the network interface, feedback data from the given employer for a given worker who performed the given job.

17. The method of claim 12, further comprising:
processing the feedback data to determine whether the feedback data reflects positive or negative feedback.

18. The method of claim 12, further comprising:
upon determining that the feedback data reflects positive feedback, updating the record for the given worker to reflect endorsement for qualifications relevant to the given job.

19. The method of claim 12, further comprising:
tracking a quantum of work completed by a given worker for the given job; and
generating an invoice for the given job based on the tracked quantum of work.

20. The method of claim 12, further comprising:
selecting the selection of the plurality of workers, the selecting comprising:
processing the records for the plurality of workers to determine worker qualifications;
processing the parameters reflecting the given job to determine job requirements; and
matching the worker qualifications to job requirements.

21. (canceled)

22. (canceled)
